(19) United States
(12) Patent Application Publication
(10) Pub. No.: US 2020/0373992 A1
(43) Pub. Date: Nov. 26, 2020

(54) CONTENTION BASED RANDOM ACCESS FOR BEAM FAILURE RECOVERY

(71) Applicant: Telefonaktiebolaget LM Ericsson (publ), Stockholm (SE)

(72) Inventors: Min WANG, Luleå (SE); Jan CHRISTOFFERSSON, Luleå (SE); Jinhua LIU, Beijing (CN)

(21) Appl. No.: 16/961,139

(22) PCT Filed: Dec. 21, 2018
(86) PCT No.: PCT/IB2018/060540

§ 371 Date: Jul. 9, 2020

(30) Foreign Application Priority Data
Jan. 11, 2018 (CN) PCT/CN2018/072205

(51) Int. Cl. H04B 7/06; H04B 7/08; H04W 74/08; H04W 80/02; H04W 56/00; H04L 5/00; H04W 76/11; H04W 76/19

(52) U.S. Cl. CPC H04B 7/0695; H04B 7/088; H04W 74/0833; H04W 80/02; H04W 76/19; H04B 7/0626; H04L 5/0051; H04W 76/11; H04W 56/001

(57) ABSTRACT

Systems and methods relating to a Contention-Based Random Access (CBRA) procedure for Beam Failure Recovery (BFR) are disclosed. In some embodiments, a method performed by a wireless device for BFR in a wireless communication system comprises detecting a beam failure and performing a CBRA procedure upon detecting a beam failure, wherein performing the CBRA procedure comprises providing, to a network node, an explicit and/or implicit indication of: a reason for the contention-based random access procedure being beam failure recovery; a new serving beam for the wireless device; and an identity of the wireless device.

### RELATED APPLICATIONS

This application claims the benefit of international patent application serial number PCT/CN2018/072205, filed Jan. 11, 2018, the disclosure of which is hereby incorporated herein by reference in its entirety.

### TECHNICAL FIELD

The present disclosure relates to Beam Failure Recovery (BFR) in a wireless communication system such as, e.g., a Third Generation Partnership Project (3GPP) New Radio (NR) system and, in particular, to contention-based random access for BFR.

### BACKGROUND

Random Access (RA) is a main function of the Medium Access Control (MAC) protocol. Beam Failure Recovery (BFR) uses RA but needs improvement to work satisfactory for this use case. The User Equipment (UE) behavior can be improved when multiple Synchronization Signal Blocks (SSBs) are available.

The evolving Fifth Generation (5G) standard in Third Generation Partnership Project (3GPP), which is referred to as New Radio (NR), is aiming to operate in a wide range of frequencies from below 1 Gigahertz (GHz) up to 100 GHz. In such a frequency range, the RA procedure in NR must be improved to mitigate the potential propagation losses at high frequency carriers.

In NR, BFR is used to enable quick recovery from beam failure. Beam failure can happen for different reasons such as, e.g., sudden blocking of a downlink beam or inefficient beam management procedures.

The BFR procedure consists of several steps. In the first step, beam failure detection is done in Layer 1 (L1) when the Block Error Rate (BLER) of a (hypothetical) Physical Downlink Control Channel (PDCCH) is above a threshold for a certain amount of time.

In a second step, new candidate beams are identified by measuring beam identification Reference Symbols (RSs) such as Channel State Information RSs (CSI-RSs) which are above a threshold with respect to L1 Reference Signal Received Power (RSRP) on the CSI-RS.

In the third step, Layer 2 (L2) is given the set of candidate beams, and a BFR is triggered which will initiate a RA procedure. Typically, this will trigger a Contention-Free Random Access (CFRA) procedure where the UE uses a dedicated preamble which is transmitted on Physical Random Access Channel (PRACH) resources that are dedicated to BFR and indicating which beam is selected. These PRACH resources are not dedicated to a specific UE but common to all UEs that perform CFRA for BFR (similar to PRACH resources dedicated to different SSBs for initial access). Hence, by the dedicated preamble and dedicated PRACH resource, the gNB (i.e., the NR base station) can conclude which UE transmitted the preamble, the reason for the transmission, and which new serving beam it indicates. In case the UE has no dedicated preamble for BFR, it has been agreed that Contention-Based Random Access (CBRA) should be used instead. However, details for how CBRA is to be performed for BFR do not exist.

In the last step, the gNB transmits a response to the BFR on the PDCCH addressed to the UE's Cell Radio Network Temporary Identifier (C-RNTI).

For NR, it has been agreed that the number of PRACH preambles per RA Channel (RACH) Occasion (RO) is not more than 64.

In NR, it has been agreed that both CFRA and CBRA are allowed for the BFR procedure. For CFRA, the main procedure has been discussed and captured by the MAC specification (3GPP Technical Specification (TS) 38.321 V15.0.0); however, the MAC details for CBRA for the BFR are still lacking.

### SUMMARY

Systems and methods relating to a Contention-Based Random Access (CBRA) procedure for Beam Failure Recovery (BFR) are disclosed. In some embodiments, a method performed by a wireless device for BFR in a wireless communication system comprises detecting a beam failure and performing a CBRA procedure upon detecting a beam failure. Performing the CBRA procedure comprises providing, to a network node, an explicit and/or implicit indication of a reason for the contention-based random access procedure being beam failure recovery, a new serving beam for the wireless device, and an identity of the wireless device.

In some embodiments, performing the contention-based random access procedure comprises transmitting, to the network node, a random access preamble; receiving, from the network node, a random access response; and transmitting, to the network node, a message comprising the identity of the wireless device and information that indicates the new serving beam for the wireless device. The message provides an implicit indication that the reason for the contention-based random access procedure is beam failure recovery. Further, in some embodiments, the information that indicates the new serving beam for the wireless device comprises an index that indicates the new serving beam, a Synchronization Signal Block (SSB) or SSB group index associated with the new serving beam, a Channel State Information Reference Symbol (CSI-RS) set index associated with the new serving beam, and/or a Transmission Configuration Indicator (TCI) state index associated with the new serving beam.

In some embodiments, the message comprises a new Medium Access Control (MAC) Control Element (CE) that comprises the information that indicates the new serving beam for the wireless device. In some other embodiments, the message comprises an existing MAC CE, wherein one or more unused bits in the existing MAC CE are used to convey the information that indicates the new serving beam for the wireless device.

In some embodiments, the identity of the wireless device is a Cell Radio Network Temporary Identifier (C-RNTI) of the wireless device, and the message comprises a C-RNTI MAC CE that comprises the C-RNTI of the wireless device.

In some embodiments, the identity of the wireless device is a C-RNTI of the wireless device, and the message comprises an extended C-RNTI MAC CE that comprises the C-RNTI of the wireless device and the information that indicates the new serving beam for the wireless device.

In some embodiments, the message further comprises information that indicates that the reason for the contention-based random access procedure is beam failure recovery.

In some embodiments, the message further comprises information that indicates an old serving beam of the wireless device for which beam failure occurred.

In some embodiments, the message further comprises radio quality measurement results for one or more other beams, one or more other beam sets, one or more other SSBs, and/or one or more other SSB groups.

In some embodiments, the identity of the wireless device is a C-RNTI of the wireless device, and performing the contention-based random access procedure comprises transmitting, to the network node, a random access preamble; receiving, from the network node, a random access response; and transmitting, to the network node, a message comprising a C-RNTI MAC CE that comprises the C-RNTI of the wireless device and information that indicates that the reason for the contention-based random access procedure is beam failure recovery. In some embodiments, the information that indicates that the reason for the contention-based random access procedure is beam failure recovery comprises a logical channel Identifier (ID) that is different from a logical channel ID comprised in a C-RNTI MAC CE for Radio Resource Control (RRC) connection reestablishment.

In some embodiments, performing the contention-based random access procedure comprises transmitting, to the network node, a random access preamble selected from a reserved preamble group for beam failure recovery. The random access preamble indicates the new serving beam for the wireless device and that the reason for the contention-based random access is beam failure recovery. Performing the contention-based random access procedure further comprises receiving, from the network node, a random access response and transmitting, to the network node, a message comprising the identity of the wireless device.

In some embodiments, performing the contention-based random access procedure comprises transmitting, to the network node, a random access preamble on a random access channel resource selected from a reserved resource group for beam failure recovery. The random access channel resource indicates the new serving beam for the wireless device and that the reason for the contention-based random access is beam failure recovery. Performing the contention-based random access procedure further comprises receiving, from the network node, a random access response and transmitting, to the network node, a message comprising the identity of the wireless device.

In some embodiments, performing the contention-based random access procedure comprises transmitting, to the network node, a random access preamble; receiving, from the network node, a random access response; and transmitting, to the network node, a message comprising a RRC message that comprises information that indicates the new serving beam for the wireless device. In some embodiments, the RRC message further comprises an indication that the reason for the contention-based random access procedure is beam failure recovery. In some embodiments, the identity of the wireless device is a C-RNTI of the wireless device, and the message comprises the RRC message and a C-RNTI MAC CE that comprises the C-RNTI of the wireless device. In some embodiments, the RRC message further comprises information that indicates an old serving beam of the wireless device. In some embodiments, the RRC message further comprises radio quality measurement results for one or more other beams, beam sets, SSBs, and/or SSB groups.

Embodiments of a wireless device are also disclosed. In some embodiments, a wireless device for beam failure recovery in a wireless communication system is adapted to detect a beam failure and perform a contention-based random access procedure upon detecting a beam failure. Performing the contention-based random access procedure comprises providing, to a network node, an explicit and/or implicit indication of a reason for the contention-based random access procedure being beam failure recovery, a new serving beam for the wireless device, and an identity of the wireless device.

In some other embodiments, a wireless device for beam failure recovery in a wireless communication system comprises one or more transmitters, one or more receivers, and processing circuitry associated with the one or more transmitters and the one or more receivers. The processing circuitry is configured to cause the wireless device to detect a beam failure and perform a contention-based random access procedure upon detecting a beam failure. Performing the contention-based random access procedure comprises providing, to a network node, an explicit and/or implicit indication of a reason for the contention-based random access procedure being beam failure recovery, a new serving beam for the wireless device, and an identity of the wireless device.

Embodiments of a method performed by a base station are also disclosed. In some embodiments, a method performed by a base station for beam failure recovery in a wireless communication system comprises performing, together with a wireless device, a contention-based random access procedure during which the base station receives, from the wireless device, an explicit and/or implicit indication of a reason for the contention-based random access procedure being beam failure recovery, a new serving beam for the wireless device, and an identity of the wireless device.

In some embodiments, performing the contention-based random access procedure comprises receiving, from the wireless device, a random access preamble; transmitting, to the wireless device, a random access response; and receiving from the wireless device, a message comprising the identity of the wireless device and information that indicates the new serving beam for the wireless device. The message provides an implicit indication that the reason for the contention-based random access procedure is beam failure recovery. Further, in some embodiments, the information that indicates the new serving beam for the wireless device comprises an index that indicates the new serving beam, a SSB or SSB group index associated with the new serving beam, a CSI-RS set index associated with the new serving beam, and/or a TCI state index associated with the new serving beam. In some embodiments, the message comprises a new MAC CE that comprises the information that indicates the new serving beam for the wireless device. In some other embodiments, the message comprises an existing MAC CE, wherein one or more unused bits in the existing MAC CE are used to convey the information that indicates the new serving beam for the wireless device.

In some embodiments, the identity of the wireless device is a C-RNTI of the wireless device, and the message comprises a C-RNTI MAC CE that comprises the C-RNTI of the wireless device.

In some embodiments, the identity of the wireless device is a C-RNTI of the wireless device, and the message comprises an extended C-RNTI MAC CE that comprises the C-RNTI of the wireless device and the information that indicates the new serving beam for the wireless device.

In some embodiments, the message further comprises information that indicates that the reason for the contention-based random access procedure is beam failure recovery.

In some embodiments, the message further comprises information that indicates an old serving beam of the wireless device.

In some embodiments, the message further comprises radio quality measurement results for one or more other beams, one or more other beam sets, one or more other SSBs, and/or one or more other SSB groups.

In some embodiments, the identity of the wireless device is a C-RNTI of the wireless device, and performing the contention-based random access procedure comprises receiving, from the wireless device, a random access preamble; transmitting, to the wireless device, a random access response; and receiving, from the wireless device, a message comprising a C-RNTI MAC CE that comprises the C-RNTI of the wireless device and information that indicates that the reason for the contention-based random access procedure is beam failure recovery. In some embodiments, the information that indicates that the reason for the contention-based random access procedure is beam failure recovery comprises a logical channel ID that is different from a logical channel ID comprised in a C-RNTI MAC CE for RRC connection re-establishment.

In some embodiments, performing the contention-based random access procedure comprises receiving, from the wireless device, a random access preamble selected from a reserved preamble group for beam failure recovery. The random access preamble indicates the new serving beam for the wireless device and that the reason for the contention-based random access is beam failure recovery. Performing the contention-based random access procedure further comprises transmitting, to the wireless device, a random access response and receiving, from the wireless device, a message comprising the identity of the wireless device.

In some embodiments, performing the contention-based random access procedure comprises receiving, from the wireless device, a random access preamble on a random access channel resource selected from a reserved resource group for beam failure recovery. The random access channel resource indicates the new serving beam for the wireless device and that the reason for the contention-based random access is beam failure recovery. Performing the contention-based random access procedure further comprises transmitting, to the wireless device, a random access response and receiving, from the wireless device, a message comprising the identity of the wireless device.

In some embodiments, performing the contention-based random access procedure comprises receiving, from the wireless device, a random access preamble; transmitting, to the wireless device, a random access response; and receiving, from the wireless device, a message comprising a RRC message that comprises information that indicates the new serving beam for the wireless device. In some embodiments, the RRC message further comprises an indication that the reason for the contention-based random access procedure is beam failure recovery. In some embodiments, the identity of the wireless device is a C-RNTI of the wireless device, and the message comprises the RRC message and a C-RNTI MAC CE that comprises the C-RNTI of the wireless device. In some embodiments, the RRC message further comprises information that indicates an old serving beam of the wireless device. In some embodiments, the RRC message further comprises radio quality measurement results for one or more other beams, beam sets, SSBs, and/or SSB groups.

In some embodiments, the method further comprises determining, based on the explicit and/or implicit indication, that the contention-based random access procedure is being performed for beam failure recovery and refraining from initiating a RRC connection re-establishment procedure upon determining that the contention-based random access procedure is being performed for beam failure recovery.

Embodiments of a base station are also disclosed. In some embodiments, a base station for beam failure recovery in a wireless communication system is adapted to perform, together with a wireless device, a contention-based random access procedure during which the base station receives, from the wireless device, an explicit and/or implicit indication of a reason for the contention-based random access procedure being beam failure recovery, a new serving beam for the wireless device, and an identity of the wireless device.

In some embodiments, a base station for beam failure recovery in a wireless communication system comprises processing circuitry configured to cause the base station to perform, together with a wireless device, a contention-based random access procedure during which the base station receives, from the wireless device, an explicit and/or implicit indication of a reason for the contention-based random access procedure being beam failure recovery, a new serving beam for the wireless device, and an identity of the wireless device.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a conventional Radio Resource Control (RRC) connection re-establishment procedure triggered by a Radio Link Failure (RLF) or Handover (HO) failure;

FIG. 2 illustrates one example of a cellular communications network according to some embodiments of the present disclosure;

FIG. 3 illustrates a Contention-Based Random Access (CBRA) procedure for Beam Failure Recovery (BFR) in accordance with at least some embodiments of the present disclosure;

FIG. 4 is a schematic block diagram of a radio access node according to some embodiments of the present disclosure;

FIG. 5 is a schematic block diagram that illustrates a virtualized embodiment of the radio access node of FIG. 4 according to some embodiments of the present disclosure;

FIG. 6 is a schematic block diagram of the radio access node of FIG. 4 according to some other embodiments of the present disclosure;

FIG. 7 is a schematic block diagram of a User Equipment device (UE) according to some embodiments of the present disclosure; and

FIG. 8 is a schematic block diagram of the UE of FIG. 7 according to some other embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless device.

Radio Access Node: As used herein, a “radio access node” or “radio network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), and a relay node.

Core Network Node: As used herein, a “core network node” is any type of node in a core network. Some examples of a core network node include, e.g., a Mobility Management Entity (MME), a Packet Data Network Gateway (P-GW), a Service Capability Exposure Function (SCEF), or the like.

Wireless Device: As used herein, a “wireless device” is any type of device that has access to (i.e., is served by) a cellular communications network by wirelessly transmitting and/or receiving signals to a radio access node(s). Some examples of a wireless device include, but are not limited to, a User Equipment device (UE) in a 3GPP network and a Machine Type Communication (MTC) device.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell;” however, particularly with respect to 5G NR concepts, beams may be used instead of cells and, as such, it is important to note that the concepts described herein are equally applicable to both cells and beams.

Some agreements concerning Beam Failure Recovery (BFR) have been made in 3GPP. In particular, the following agreements have been made in 3GPP for NR:
BFR using a dedicated Physical Radio Access Channel (PRACH) preamble is specified in the Medium Access Control (MAC) and triggered upon indication from the physical layer (i.e., the PHY layer or Layer 1, which is referred to as L1). It has been assumed that the PHY layer does the detection of the beam failure.
Beam selection is specified in the MAC similar to the Handover (HO) case.
The UE uses Contention-Free Random Access (CFRA) when there is a beam associated to a dedicated “preamble/resource” and the beam is above a threshold. Otherwise, the UE uses Contention-Based Random Access (CBRA) for BFR.

From the above agreements, both CFRA and CBRA are allowed for the BFR procedure. For CFRA, the main procedure has been discussed and captured by the MAC specification for 3GPP NR; however, the MAC details for CBRA for BFR are still lacking. Based on existing CBRA procedure in Radio Resource Control (RRC) connected state, it is expected that in case CBRA is used, the UE selects a preamble randomly in Message 1, the UE MAC needs to include its Cell Radio Network Temporary Identifier (C-RNTI) MAC Control Element (CE) in message 3 upon reception of the Random Access Response (RAR) message, and, optionally, RRC connection setup request may be also included in message 3.

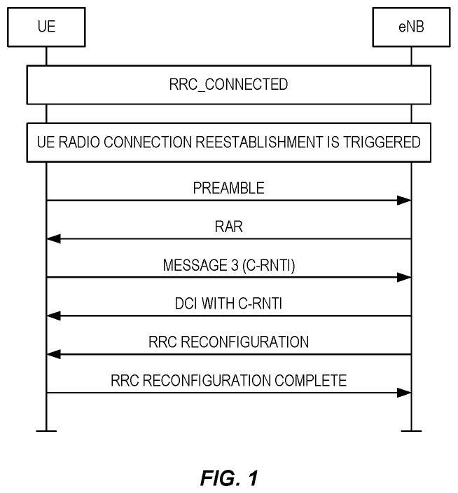

Upon reception of the message 3, the NR base station (gNB) is not able to distinguish the Random Access (RA) triggered by a BFR from other RA events triggered for other reasons such as, e.g., RA triggered due to Physical Uplink Control Channel (PUCCH) Scheduling Request (SR) failure, RA triggered due to Radio Link Failure (RLF), RA triggered due to the need to update the timing advance, etc. In this case, the gNB may take a wrong action. For example, the gNB may instruct the UE to do the ordinary RRC connection re-establishment procedure. The ordinary RRC connection re-establishment for CBRA for BFR is redundant and may lead to unnecessary service interruption and additional User Plane (UP) latency. One example of the RRC connection re-establishment procedure is illustrated in FIG. 1. In particular, FIG. 1 illustrates the ordinary RRC connection re-establishment procedure, which may be triggered by RLF or HO failure.

Systems and methods are disclosed herein that provide an improved CBRA procedure for BFR. In some embodiments, indicators are included in Message 3 (Msg3) to indicate the reason for RA (i.e., to indicate that the reason is BFR) and the new serving beam together with the C-RNTI of the UE. In some embodiments, dedicated PRACH resources for BFR may also be used for the CBRA for BFR. This means that the reason for the CBRA and the indicated beam will be known to the gNB already when receiving the preamble. In some embodiments, in Msg3, the C-RNTI is included which makes the gNB aware of also which UE that is doing the BFR. In case the normal PRACH resources would be used, then Msg3 would also need to include an indication of the reason for the CBRA.

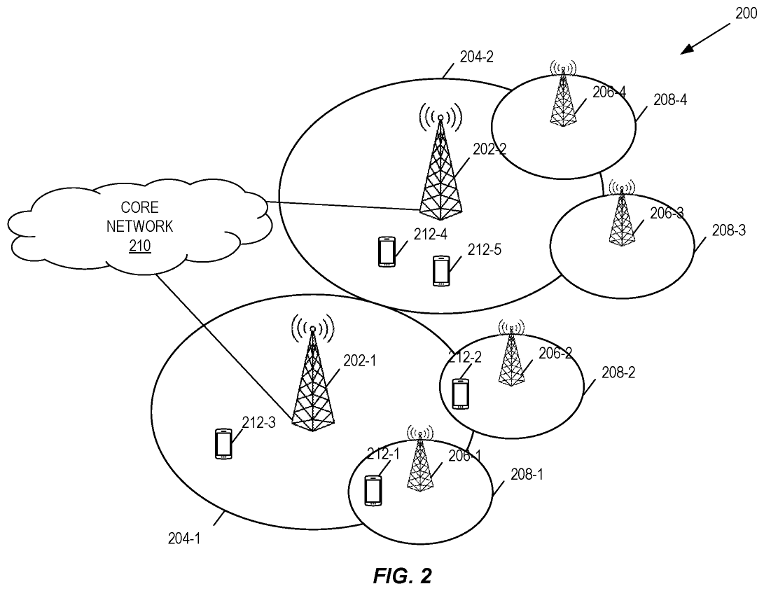

In this regard, FIG. 2 illustrates one example of a wireless communication system, which is also referred to herein as a cellular communications network 200, according to some embodiments of the present disclosure. In the embodiments described herein, the cellular communications network 200 is a 5G NR network. In this example, the cellular communications network 200 includes base stations 202-1 and 202-2, which in 5G NR are referred to as gNBs, controlling corresponding macro cells 204-1 and 204-2. The base stations 202-1 and 202-2 are generally referred to herein collectively as base stations 202 and individually as base station 202. Likewise, the macro cells 204-1 and 204-2 are generally referred to herein collectively as macro cells 204 and individually as macro cell 204. The cellular communications network 200 may also include a number of low power nodes 206-1 through 206-4 controlling corresponding small cells 208-1 through 208-4. The low power nodes 206-1 through 206-4 can be small base stations (such as pico or femto base stations) or Remote Radio Heads (RRHs), or the like. Notably, while not illustrated, one or more of the small cells 208-1 through 208-4 may alternatively be provided by the base stations 202. The low power nodes 206-1 through 206-4 are generally referred to herein collectively as low power nodes 206 and individually as low power node 206. Likewise, the small cells 208-1 through 208-4 are generally referred to herein collectively as small cells 208 and individually as small cell 208. The base stations 202 (and optionally the low power nodes 206) are connected to a core network 210.

The base stations 202 and the low power nodes 206 provide service to wireless devices 212-1 through 212-5 in the corresponding cells 204 and 208. The wireless devices 212-1 through 212-5 are generally referred to herein collectively as wireless devices 212 and individually as wireless device 212. The wireless devices 212 are also sometimes referred to herein as UEs.

As described below, embodiments of the present disclosure provide a CBRA procedure for BFR. In general, in each of the embodiments disclosed herein, the CBRA procedure is performed where the wireless device 212 provides, to the base station 202 (or likewise the low power node 206), an explicit and/or implicit indication of the reason for the CBRA being BFR, a new serving beam of the wireless device 212, and an identity of the wireless device 212. Based on this information, the base station 202 is able to determine that the CBRA procedure is being performed for BFR and, as such, take one or more appropriate actions such as, e.g., refraining from triggering a RRC connection re-establishment procedure, which is redundant. As a result, an efficient CBRA for BFR is provided.

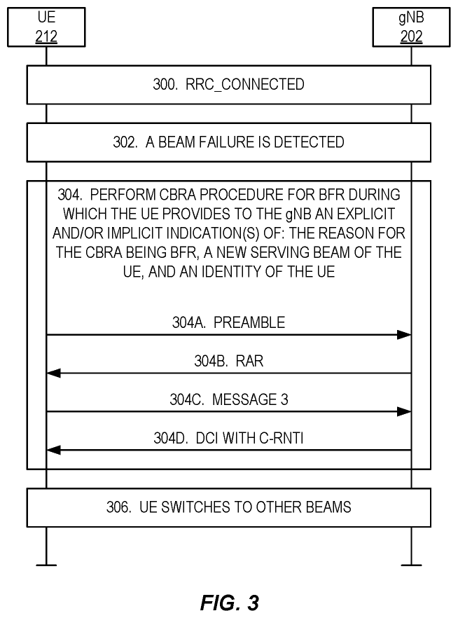

In this regard, FIG. 3 illustrates the operation of the wireless device 212 (referred to here as UE 212) and the base station 202 (referred to here as gNB 202) in accordance with at least some of the embodiments disclosed herein. As illustrated, the wireless device 212 is in an RRC connected state (step 300). While in RRC connected state, the wireless device 212 detects a beam failure (step 302). The beam failure is detected using any suitable beam failure detection scheme. The particular beam failure detection scheme used by the wireless device 212 is not the focus of the present disclosure. As part of the beam failure detection, the wireless device 212 preferably detects one or more candidate beams and selects one of the candidate beams as a new serving beam (i.e., as a new beam to replace the failed beam, which is referred to herein as an old serving beam of the wireless device 212).

Upon detecting the beam failure, the wireless device 212 triggers a CBRA procedure. The wireless device 212 and the gNB 202 operate together to perform the CBRA procedure (step 304). As illustrated, the CBRA procedure includes transmission of a preamble (i.e., a RA preamble) from the wireless device 212 to the gNB 202 (step 304A). Upon detecting the preamble, the gNB 202 transmits a RAR (step 304B). Upon receiving the RAR, the wireless device 212 transmits a message (referred to in 3GPP as Msg3) to the gNB 202 (step 304C). The gNB 202 then transmits Downlink Control Information (DCI) including the C-RNTI of the wireless device 212, as will be appreciated by one of skill in the art (step 304D). The wireless device 212 then switches to the new serving beam (step 306).

As described below in detail, during the CBRA procedure, the wireless device 212 provides, to the gNB 202, an explicit and/or implicit indication of the reason for the CBRA procedure being BFR, a new serving beam for the wireless device 212, and an identity of the wireless device 212. In some embodiments, this information is included in Msg3 (i.e., in the message of step 304C). In some other embodiments, at least some of this information is implied by the particular preamble transmitted and/or the PRACH resources used for transmission of the preamble in step 304A. Additional details and embodiments are disclosed below.

More specifically, there are also several options to implement the improvements. In all embodiments that are described below, the wireless device 212 skips the UE actions that are triggered upon the RRC connection re-establishment procedure (such as the UE actions that are specified in RRC specification, 3GPP TS 36.331 V15.0.0 and 38.331 V15.0.0, both in section 5.3.7 RRC connection re-establishment). In the CBRA procedure, the wireless device 212 indicates that the CBRA is triggered for BFR.

### First Embodiment

In a first embodiment, an extension of Message 3 is used to identify the BFR triggered RA.

In a first option, in Message 3, the UE MAC entity includes its C-RNTI MAC CE together with the index or information of the new serving beam. In other words, the Msg3 sent from the UE 212 to the gNB 202 in step 304C includes the C-RNTI MAC CE of the UE MAC entity together with an index or other information indicating the new serving beam of the UE 212. The network (e.g., the gNB 202) determines that the UE 212 associated with the C-RNTI has triggered a BFR upon reception of this Message 3.

In a second option, the UE MAC carries its C-RNTI MAC CE and other index or information to indicate the new serving beam, such as the index of Synchronization Signal Block (SSB) or SSB group, or index of the Channel State Information Reference Symbol (CSI-RS) set, or the index of the Transmission Configuration Indicator (TCI) state which are associated with the uplink/downlink beam/beam set that are used for the RA. In other words, the Msg3 sent from the UE 212 to the gNB 202 in step 304C includes the C-RNTI MAC CE of the UE MAC entity together with an index or other information indicating the new serving beam of the UE 212, where this index or other information indicating the new serving beam of the UE 212 is, e.g., the index of the SSB or SSB group associated with the new serving beam, the index of the CSI-RS set associated with the new serving beam, or the index of the TCI state associated with the new serving beam.

In a third option, for all options that are described above, a new MAC CE to carry the index that is used to indicate the new serving beam may be defined and included in Message 3.

In a fourth option, the C-RNTI MAC CE is extended to carry the index that is used to indicate the new serving beam.

Another option is to reuse fields in the existing MAC CEs, such as any available reserved (R) bits, to carry the index that is used to indicate the new serving beam.

In all above options, an additional field may be also added to indicate the type of the RA events, whether the RA is triggered for BFR, or another purpose.

In all above options, the UE MAC may also carry the index or information of the old serving beam that has the failure. In all above options, some additional fields carrying radio quality measurement results of other beams/beam set/SSB/SSB groups may also be added so that the gNB 202 can consider whether to use these measurement results to indicate candidate beam/beams to the wireless device 212 for a beam switch.

### Second Embodiment

In a second embodiment, a new C-RNTI MAC CE can be defined to indicate BFR. For instance, one new logical channel identifier (ID), which is different from the logical channel ID of C-RNTI MAC CE for RRC connection re-establishment, can be defined for C-RNTI MAC CE for BFR. In other words, Msg3 in step 304C includes the new C-RNTI MAC CE of the UE MAC entity of the UE 212, where the new C-RNTI MAC CE includes the new logical channel ID defined for BFR. This new logical channel ID is different than the logical channel ID of existing C-RNTI MAC CE used for RRC connection re-establishment. In this case, both the new MAC CE (for indicating BFR) and the ordinary C-RNTI MAC CE (for RRC connection re-establishment) would be carried together. The gNB can determine if the PRACH transmission is triggered by RRC connection re-establishment or BFR based on the logical channel ID in the C-RNTI MAC CE.

The benefit of such solution is that the Message 3 size change is avoided compared to that in RRC connection re-establishment, which simplified the uplink grant allocation for Message 3.

### Third Embodiment

In a third embodiment, Message 1 is used to identify that BFR triggered CBRA and the new serving beam. Message 1 refers to the preamble transmitted in step 304A.

In CFRA for BFR, the wireless device 212 uses its dedicated preamble, which indicates the wireless device 212, and transmits this preamble on a dedicated PRACH resource that indicates the desired new serving beam. In this embodiment, the dedicated PRACH resources are also used for CBRA for BFR to indicate the new serving beam and that the reason for RA is BFR. In this embodiment, the wireless device 212 indicates its C-RNTI in Message 3 to identify itself to the gNB 202. As one example, a PRACH preamble group can be configured specially for BFR for a group of UEs; as another example, a special set of time-frequency resources can be configured for BFR and a UE can contend the time-frequency resource for PRACH transmission.

In other words, in one example of the third embodiment, the UE 212 transmits a preamble selected from a reserved preamble group in step 304A. The preamble indicates that the RA is triggered for BFR. As another example, the UE 212 transmits a preamble with the resources selected from a reserved resource group. The resource indicates that the RA is triggered for BFR. The UE 212 provides its identity, which in this example is the C-RNTI of the UE 212, in Msg3 in step 304C.

### Fourth Embodiment

In a fourth embodiment, during RA for BFR, Message 3 carries a light RRC message, which includes the indicator of the RA access event and the index that indicates the new serving beam. The RRC message may also carry the index or information of the old serving beam that has the failure.

In this embodiment, the UE MAC entity includes its C-RNTI MAC CE and also carries a light RRC message, which may comprise only minimal RRC message headers plus the index that indicates the new serving beam. An indicator of the RA access event (whether it is RA triggered for BFR) can be also added. Optionally, the UE MAC may also carry radio quality measurement results of other beams/beam set/SSB/SSB groups in the RRC message.

In other words, Msg3 sent in step 304C includes the C-RNTI MAC CE as well as a light RRC message. This light RRC message may comprise only some of the RRC message headers (e.g., the least amount of RRC message headers needed to properly send and receive the RRC message). In addition, this light RRC message includes the index or information that indicates the new serving beam. Optionally, this light RRC message may include an indicator of the RA access event (e.g., an indicator of whether the reason for this RA is BFR).

Accordingly, the RRC may define one or multiple new information elements for the added information as described above.

### Fifth Embodiment

In a fifth embodiment, upon reception of a RA, the gNB 202 determines if the RA is triggered for BFR based on the received information, e.g., in Message 3 according to any of the above embodiments. The BFR can be determined based on either the additional information in Message 3 or the redefined C-RNTI MAC CE.

Once the BFR is determined, the gNB 202 knows that the RA is triggered by BFR and, as such, radio resource reconfiguration for the wireless device 212 is not necessary. As such, the gNB 202 refrains from triggering a RRC connection re-establishment procedure for the wireless device 212. The gNB 202 may provide further signaling to instruct the wireless device 212 for further actions. For example, the gNB 202 may indicate the beam to which the wireless device 212 should consider switching.

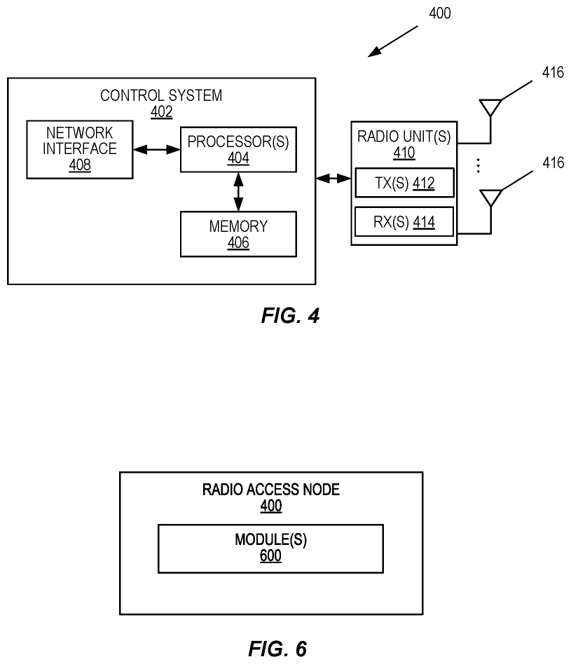

Now, a discussion of some additional aspects that are applicable to all of the embodiments described above is provided. FIG. 4 is a schematic block diagram of a radio access node 400 according to some embodiments of the present disclosure. The radio access node 400 may be, for example, a base station 202 or 206. As illustrated, the radio access node 400 includes a control system 402 that includes one or more processors 404 (e.g., Central Processing Units (CPUs), Application Specific Integrated Circuits (ASICs), Field Programmable Gate Arrays (FPGAs), and/or the like), memory 406, and a network interface 408. In addition, the radio access node 400 includes one or more radio units 410 that each includes one or more transmitters 412 and one or more receivers 414 coupled to one or more antennas 416. In some embodiments, the radio unit(s) 410 is external to the control system 402 and connected to the control system 402 via, e.g., a wired connection (e.g., an optical cable). However, in some other embodiments, the radio unit(s) 410 and potentially the antenna(s) 416 are integrated together with the control system 402. The one or more processors 404 operate to provide one or more functions of a radio access node 400 as described herein (e.g., the functions of the base station or gNB 202 described above with respect to FIG. 3). In some embodiments, the function(s) are implemented in software that is stored, e.g., in the memory 406 and executed by the one or more processors 404.

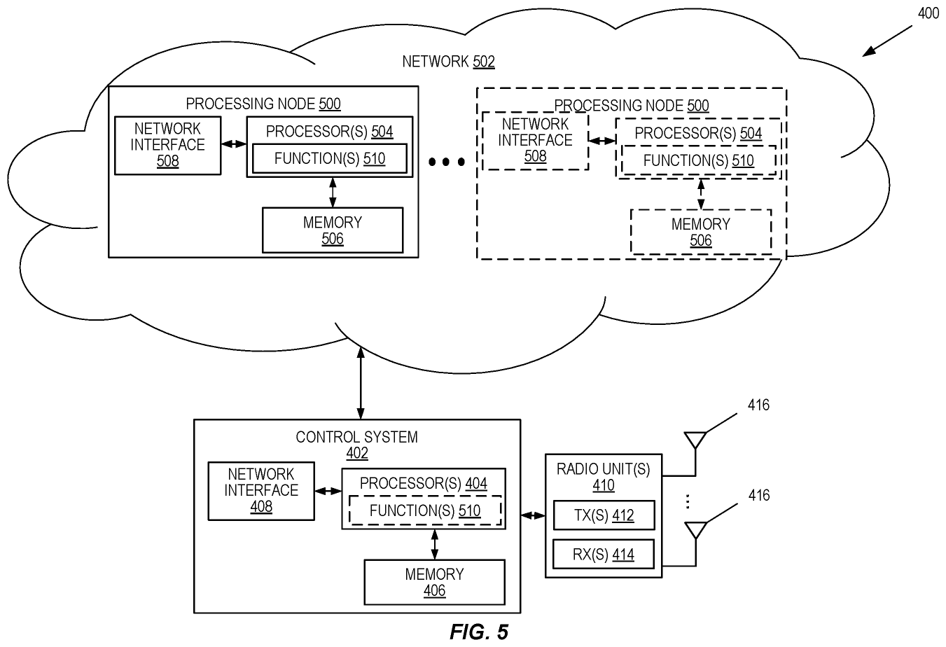

FIG. 5 is a schematic block diagram that illustrates a virtualized embodiment of the radio access node 400 according to some embodiments of the present disclosure. This discussion is equally applicable to other types of network nodes. Further, other types of network nodes may have similar virtualized architectures.

As used herein, a “virtualized” radio access node is an implementation of the radio access node 400 in which at least a portion of the functionality of the radio access node 400 is implemented as a virtual component(s) (e.g., via a virtual machine(s) executing on a physical processing node(s) in a network(s)). As illustrated, in this example, the radio access node 400 includes the control system 402 that includes the one or more processors 404 (e.g., CPUs, ASICs, FPGAs, and/or the like), the memory 406, and the network interface 408 and the one or more radio units 410 that each includes the one or more transmitters 412 and the one or more receivers 414 coupled to the one or more antennas 416, as described above. The control system 402 is connected to the radio unit(s) 410 via, for example, an optical cable or the like. The control system 402 is connected to one or more processing nodes 500 coupled to or included as part of a network(s) 502 via the network interface 408. Each processing node 500 includes one or more processors 504 (e.g., CPUs, ASICs, FPGAs, and/or the like), memory 506, and a network interface 508.

In this example, functions 510 of the radio access node 400 described herein (e.g., the functions of the base station or gNB 202 described above with respect to FIG. 3) are implemented at the one or more processing nodes 500 or distributed across the control system 402 and the one or more processing nodes 500 in any desired manner. In some particular embodiments, some or all of the functions 510 of the radio access node 400 described herein are implemented as virtual components executed by one or more virtual machines implemented in a virtual environment(s) hosted by the processing node(s) 500. As will be appreciated by one of ordinary skill in the art, additional signaling or communication between the processing node(s) 500 and the control system 402 is used in order to carry out at least some of the desired functions 510. Notably, in some embodiments, the control system 402 may not be included, in which case the radio unit(s) 410 communicate directly with the processing node(s) 500 via an appropriate network interface(s).

In some embodiments, a computer program including instructions which, when executed by at least one processor, causes the at least one processor to carry out the functionality of radio access node 400 or a node (e.g., a processing node 500) implementing one or more of the functions 510 of the radio access node 400 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 6 is a schematic block diagram of the radio access node 400 according to some other embodiments of the present disclosure. The radio access node 400 includes one or more modules 600, each of which is implemented in software. The module(s) 600 provide the functionality of the radio access node 400 described herein (e.g., the functions of the base station or gNB 202 described above with respect to FIG. 3). This discussion is equally applicable to the processing node 500 of FIG. 5 where the modules 600 may be implemented at one of the processing nodes 500 or distributed across multiple processing nodes 500 and/or distributed across the processing node(s) 500 and the control system 402.

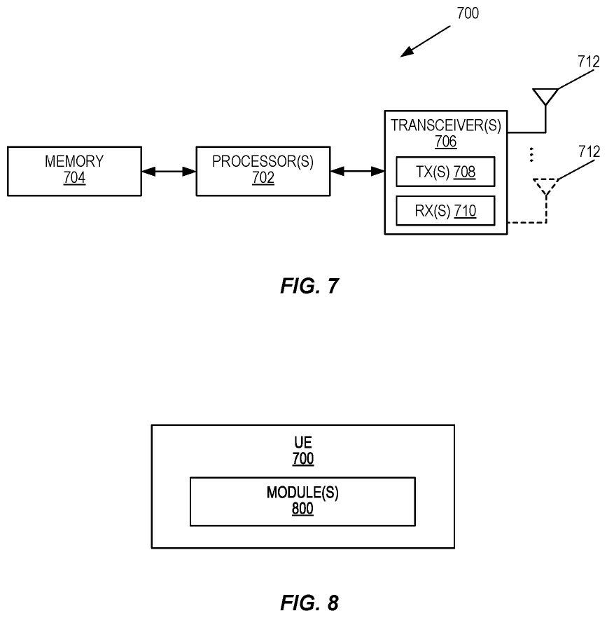

FIG. 7 is a schematic block diagram of a UE 700 according to some embodiments of the present disclosure. As illustrated, the UE 700 includes one or more processors 702 (e.g., CPUs, ASICs, FPGAs, and/or the like), memory 704, and one or more transceivers 706 each including one or more transmitters 708 and one or more receivers 710 coupled to one or more antennas 712. In some embodiments, the functionality of the UE 700 described above (e.g., the functions of the UE 212 described above with respect to FIG. 3) may be fully or partially implemented in software that is, e.g., stored in the memory 704 and executed by the processor(s) 702.

In some embodiments, a computer program including instructions which, when executed by at least one processor, causes the at least one processor to carry out the functionality of the UE 700 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 8 is a schematic block diagram of the UE 700 according to some other embodiments of the present disclosure. The UE 700 includes one or more modules 800, each of which is implemented in software. The module(s) 800 provide the functionality of the UE 700 described herein (e.g., the functions of the UE 212 described above with respect to FIG. 3).

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some exemplary embodiments include:

### Embodiment 1

A method performed by a wireless device (212) for beam failure recovery in a wireless communication system (200), comprising:
detecting (302) a beam failure;
performing (304) a contention-based random access procedure upon detecting a beam failure, wherein performing the contention-based random access procedure comprises providing, to a network node (202), an explicit and/or implicit indication of:
   a reason for the contention-based random access procedure being beam failure recovery;
   a new serving beam for the wireless device (212); and
   an identity of the wireless device (212).

### Embodiment 2

The method of embodiment 1 wherein performing the contention-based random access procedure comprises: transmitting (304A), to the network node (202), a random access preamble; receiving (304B), from the network node (202), a random access response; and transmitting (304C), to the network node (202), a message comprising the identity of the wireless device (212) and information that indicates the new serving beam for the wireless device (212), wherein the message provides an implicit indication that the reason for the contention-based random access procedure is beam failure recovery.

### Embodiment 3

The method of embodiment 2 wherein the identity of the wireless device (212) is a Cell Radio Network Temporary Identifier, C-RNTI, of the wireless device (212), and the message comprises a C-RNTI Medium Access Control, MAC, Control Element, CE, that comprises the C-RNTI of the wireless device (212).

### Embodiment 4

The method of embodiment 2 or 3 wherein the information that indicates the new serving beam for the wireless device (212) comprises a beam index of the new serving beam, a Synchronization Signal Block, SSB, or SSB group index associated with the new serving beam, a Channel State Information Reference Symbol, CSI-RS, set index associated with the new serving beam, and/or a Transmission Configuration Indication, TCI, state index associated with the new serving beam.

### Embodiment 5

The method of any one of embodiments 2 to 4 wherein the message comprises a new MAC CE that comprises the information that indicates the new serving beam for the wireless device (212).

### Embodiment 6

The method of any one of embodiments 2 to 4 wherein the message comprises an existing MAC CE, wherein one or more unused bits in the existing MAC CE are used to convey the information that indicates the new serving beam for the wireless device (212).

### Embodiment 7

The method of embodiment 2 wherein the identity of the wireless device (212) is a Cell Radio Network Temporary Identifier, C-RNTI, of the wireless device (212), and the message comprises an extended C-RNTI Medium Access Control, MAC, Control Element, CE, that comprises the C-RNTI of the wireless device (212) and the information that indicates the new serving beam for the wireless device (212).

### Embodiment 8

The method of any one of embodiments 2 to 7 wherein the message further comprises information that indicates that the reason for the contention-based random access procedure is beam failure recovery.

### Embodiment 9

The method of any one of embodiments 2 to 8 wherein the message further comprises information that indicates an old serving beam of the wireless device (212).

### Embodiment 10

The method of any one of embodiments 2 to 9 wherein the message further comprises radio quality measurement results for one or more other beams, beam sets, Synchronization Signal Blocks, SSBs, and/or SSB groups.

### Embodiment 11

The method of embodiment 2 wherein the identity of the wireless device (212) is a Cell Radio Network Temporary Identifier, C-RNTI, of the wireless device (212), and the message comprises a C-RNTI Medium Access Control, MAC, Control Element, CE, that comprises the C-RNTI of the wireless device (212) and information that indicates that the reason for the contention-based random access procedure is beam failure recovery.

### Embodiment 12

The method of embodiment 11 wherein the information that indicates that the reason for the contention-based random access procedure is beam failure recovery comprises a logical channel identifier, ID, that is different from a logical channel ID comprised in a C-RNTI MAC CE for Radio Resource Control, RRC, connection re-establishment.

### Embodiment 13

The method of embodiment 1 wherein performing the contention-based random access procedure comprises: transmitting (304A), to the network node (202), a dedicated random access preamble on dedicated random access channel resources, wherein the dedicated random access preamble indicates the identity of the wireless device (212) and the dedicated random access channel resources indicate the new serving beam for the wireless device (212); receiving (304B), from the network node (202), a random access response; and transmitting (304C), to the network node (202), a message comprising the identity of the wireless device (212).

### Embodiment 14

The method of embodiment 1 wherein performing the contention-based random access procedure comprises:
transmitting (304A), to the network node (202), a random access preamble;
receiving (304B), from the network node (202), a random access response; and
transmitting (304C), to the network node (202), a message comprising a Radio Resource Control, RRC, message that comprises:
   an indication that the reason for the contention-based random access procedure is beam failure recovery; and
   information that indicates the new serving beam for the wireless device (212).

### Embodiment 15

The method of embodiment 14 wherein the identity of the wireless device (212) is a Cell Radio Network Temporary Identifier, C-RNTI, of the wireless device (212), and the message comprises a C-RNTI Medium Access Control, MAC, Control Element, CE, that comprises the C-RNTI of the wireless device (212) and the RRC message.

### Embodiment 16

The method of embodiment 14 or 15 wherein the RRC message further comprises information that indicates an old serving beam of the wireless device (212).

### Embodiment 17

The method of any one of embodiments 14 to 16 wherein the RRC message further comprises radio quality measurement results for one or more other beams, beam sets, Synchronization Signal Blocks, SSBs, and/or SSB groups.

### Embodiment 18

A method performed by a base station (202) for beam failure recovery in a wireless communication system (200), comprising:
performing, together with a wireless device (212), a contention-based random access procedure, wherein performing the contention-based random access procedure comprises receiving (304), from the wireless device (212), an explicit and/or implicit indication of:
   a reason for the contention-based random access procedure being beam failure recovery;
   a new serving beam for the wireless device (212); and
   an identity of the wireless device (212).

### Embodiment 19

The method of embodiment 18 wherein performing the contention-based random access procedure comprises: receiving (304A), from the wireless device (212), a random access preamble; transmitting (304B), to the wireless device (212), a random access response; and receiving (304C), from the wireless device (212), a message comprising the identity of the wireless device (212) and information that indicates the new serving beam for the wireless device (212), wherein the message provides an implicit indication that the reason for the contention-based random access procedure is beam failure recovery.

### Embodiment 20

The method of embodiment 19 wherein the identity of the wireless device (212) is a Cell Radio Network Temporary Identifier, C-RNTI, of the wireless device (212), and the message comprises a C-RNTI Medium Access Control, MAC, Control Element, CE, that comprises the C-RNTI of the wireless device (212).

### Embodiment 21

The method of embodiment 19 or 20 wherein the information that indicates the new serving beam for the wireless device (212) comprises a beam index of the new serving beam, a Synchronization Signal Block, SSB, or SSB group index associated with the new serving beam, a Channel State Information Reference Symbol, CSI-RS, set index associated with the new serving beam, and/or a Transmission Configuration Indication, TCI, state index associated with the new serving beam.

### Embodiment 22

The method of any one of embodiments 19 to 21 wherein the message comprises a new MAC CE that comprises the information that indicates the new serving beam for the wireless device (212).

### Embodiment 23

The method of any one of embodiments 19 to 21 wherein the message comprises an existing MAC CE, wherein one or more unused bits in the existing MAC CE are used to convey the information that indicates the new serving beam for the wireless device (212).

### Embodiment 24

The method of embodiment 19 wherein the identity of the wireless device (212) is a Cell Radio Network Temporary Identifier, C-RNTI, of the wireless device (212), and the message comprises an extended C-RNTI Medium Access Control, MAC, Control Element, CE, that comprises the C-RNTI of the wireless device (212) and the information that indicates the new serving beam for the wireless device (212).

### Embodiment 25

The method of any one of embodiments 19 to 24 wherein the message further comprises information that indicates that the reason for the contention-based random access procedure is beam failure recovery.

### Embodiment 26

The method of any one of embodiments 19 to 25 wherein the message further comprises information that indicates an old serving beam of the wireless device (212).

### Embodiment 27

The method of any one of embodiments 19 to 26 wherein the message further comprises radio quality measurement results for one or more other beams, beam sets, Synchronization Signal Block, SSBs, and/or SSB groups.

### Embodiment 28

The method of embodiment 19 wherein the identity of the wireless device (212) is a Cell Radio Network Temporary Identifier, C-RNTI, of the wireless device (212), and the message comprises a C-RNTI Medium Access Control, MAC, Control Element, CE, that comprises the C-RNTI of the wireless device (212) and information that indicates that the reason for the contention-based random access procedure is beam failure recovery.

### Embodiment 29

The method of embodiment 28 wherein the information that indicates that the reason for the contention-based random access procedure is beam failure recovery comprises a logical channel identifier, ID, that is different from a logical channel ID comprised in a C-RNTI MAC CE for Radio Resource Control, RRC, connection re-establishment.

### Embodiment 30

The method of embodiment 18 wherein performing the contention-based random access procedure comprises: receiving (304A), from the wireless device (212), a dedicated random access preamble on dedicated random access channel resources, wherein the dedicated random access preamble indicates the identity of the wireless device (212) and the dedicated random access channel resources indicate the new serving beam for the wireless device (212); transmitting (304B), to the wireless device (212), a random access response; and receiving (304C), from the wireless device (212), a message comprising the identity of the wireless device (212).

### Embodiment 31

The method of embodiment 18 wherein performing the contention-based random access procedure comprises:
receiving (304A), from the wireless device (212), a random access preamble;
transmitting (304B), to the wireless device (212), a random access response; and
receiving (304C), from the wireless device (212), a message comprising a Radio Resource Control, RRC, message that comprises:
   an indication that the reason for the contention-based random access procedure is beam failure recovery; and
   information that indicates the new serving beam for the wireless device (212).

### Embodiment 32

The method of embodiment 31 wherein the identity of the wireless device (212) is a Cell Radio Network Temporary Identifier, C-RNTI, of the wireless device (212), and the message comprises a C-RNTI Medium Access Control, MAC, Control Element, CE, that comprises the C-RNTI of the wireless device (212) and the RRC message.

### Embodiment 33

The method of embodiment 31 or 32 wherein the RRC message further comprises information that indicates an old serving beam of the wireless device (212).

### Embodiment 34

The method of any one of embodiments 31 to 33 wherein the RRC message further comprises radio quality measurement results for one or more other beams, beam sets, Synchronization Signal Blocks, SSBs, and/or SSB groups.

### Embodiment 35

The method of any one of embodiments 18 to 34 further comprising: determining, based on the explicit and/or implicit indication, that the contention-based random access procedure is being performed for beam failure recovery; and refraining from initiating a RRC connection re-establishment procedure upon determining that the contention-based random access procedure is being performed for beam failure recovery.

### Embodiment 36

A wireless device (700) for beam failure recovery in a wireless communication system (200), the wireless device (700) comprising: processing circuitry (702) configured to perform any of the steps of any of embodiments 1 to 18; and power supply circuitry configured to supply power to the wireless device (700).

### Embodiment 37

A base station (400) for beam failure recovery in a wireless communication system (200), the base station (400) comprising: processing circuitry (404) configured to perform any of the steps of any one of embodiments 18 to 35; and power supply circuitry configured to supply power to the base station (400).

### Embodiment 38

A User Equipment, UE, (700) for beam failure recovery in a wireless communication system (200), the UE (700) comprising: an antenna (712) configured to send and receive wireless signals; radio front-end circuitry connected to the antenna (712) and to processing circuitry (702), and configured to condition signals communicated between the antenna (712) and the processing circuitry (702); the processing circuitry (702) being configured to perform any of the steps of any one of embodiments 1 to 18; an input interface connected to the processing circuitry (702) and configured to allow input of information into the UE (700) to be processed by the processing circuitry (702); an output interface connected to the processing circuitry (702) and configured to output information from the UE (700) that has been processed by the processing circuitry (702); and a battery connected to the processing circuitry (702) and configured to supply power to the UE (700).

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
AP Access Point
ASIC Application Specific Integrated Circuit
BFR Beam Failure Recovery
BLER Block Error Rate
CBRA Contention-Based Random Access
CE Control Element
CFRA Contention-Free Random Access
CPU Central Processing Unit
C-RNTI Cell Radio Network Temporary Identifier
CSI-RS Channel State Information Reference Symbol
DCI Downlink Control Information
DSP Digital Signal Processor
eNB Enhanced or Evolved Node B
FPGA Field Programmable Gate Array
GHz Gigahertz
gNB New Radio Base Station
HO Handover
ID Identifier
LTE Long Term Evolution
MAC Medium Access Control
MME Mobility Management Entity
MTC Machine Type Communication
NR New Radio
OTT Over-the-Top
PDCCH Physical Downlink Control Channel
P-GW Packet Data Network Gateway
PRACH Physical Random Access Channel
PUCCH Physical Uplink Control Channel
RA Random Access
RACH Random Access Channel
RAM Random Access Memory
RAN Radio Access Network
RAR Random Access Response
RLF Radio Link Failure
RO Random Access Channel Occasion
ROM Read Only Memory
RRC Radio Resource Control
RRH Remote Radio Head
RS Reference Symbol
RSRP Reference Signal Received Power
SCEF Service Capability Exposure Function
SR Scheduling Request
SSB Synchronization Signal Block
TCI Transmission Configuration Indicator
TS Technical Specification
UE User Equipment
UP User Plane

Those skilled in the art will recognize improvements and modifications to the embodiments of the present disclosure. All such improvements and modifications are considered within the scope of the concepts disclosed herein.

1. A method performed by a wireless device for beam failure recovery in a wireless communication system, comprising:
detecting a beam failure; and
performing a contention-based random access procedure upon detecting the beam failure, wherein performing the contention-based random access procedure comprises:
transmitting, to a network node, a random access preamble;
receiving, from the network node, a random access response; and
transmitting, to the network node, a message comprising an identity of the wireless device and information that indicates a new serving beam for the wireless device, wherein:
the message provides an implicit indication that a reason for the contention-based random access procedure is beam failure recovery; and
the message comprises an existing Medium Access Control, MAC, Control Element, CE, where one or more unused bits in the existing MAC CE are used to convey the information that indicates the new serving beam for the wireless device.

2. (canceled)

3. The method of claim 1 wherein the information that indicates the new serving beam for the wireless device comprises:
an index that indicates the new serving beam;
a Synchronization Signal Block, SSB, or SSB group index associated with the new serving beam;
a Channel State Information Reference Symbol, CSI-RS, set index associated with the new serving beam; and/or
a Transmission Configuration Indicator, TCI, state index associated with the new serving beam.

4. (canceled)

5. (canceled)

6. The method of claim 1 wherein the identity of the wireless device is a Cell Radio Network Temporary Identifier, C-RNTI, of the wireless device, and the message comprises a C-RNTI MAC CE that comprises the C-RNTI of the wireless device.

7. The method of claim 3 wherein the identity of the wireless device is a Cell Radio Network Temporary Identifier, C-RNTI, of the wireless device, and the message comprises an extended C-RNTI MAC CE that comprises the C-RNTI of the wireless device and the information that indicates the new serving beam for the wireless device.

8. The method of claim 1 wherein the message further comprises information that indicates that the reason for the contention-based random access procedure is beam failure recovery.

9. The method of claim 1 wherein the message further comprises information that indicates an old serving beam of the wireless device for which the beam failure occurred.

10. The method of claim 1 wherein the message further comprises radio quality measurement results for:
one or more other beams;
one or more other beam sets;
one or more other SSBs; and/or
one or more other SSB groups.

11. The method of claim 1 wherein the identity of the wireless device is a Cell Radio Network Temporary Identifier, C-RNTI, of the wireless device, and the message comprises a C-RNTI MAC CE that comprises the C-RNTI of the wireless device.

12. The method of claim 11 wherein the implicit indication that the reason for the contention-based random access procedure is beam failure recovery comprises a logical channel identifier, ID, that is different from a logical channel ID comprised in a C-RNTI MAC CE for Radio Resource Control, RRC, connection re-establishment.

13. The method of claim 1 wherein transmitting, to the network node, the random access preamble comprises transmitting, to the network node, a random access preamble selected from a reserved preamble group for beam failure recovery, wherein the random access preamble indicates the new serving beam and that the reason for the contention-based random access procedure is beam failure recovery.

14. The method of claim 1 wherein transmitting, to the network node, the random access preamble comprises transmitting, to the network node, a random access preamble on a random access channel resource selected from a reserved resource group for beam failure recovery, wherein the random access channel resource indicates the new serving beam and that the reason for the contention-based random access procedure is beam failure recovery.

15. The method of claim 1 wherein the message comprises a Radio Resource Control, RRC, message that comprises the information that indicates the new serving beam for the wireless device.

16. The method of claim 15 wherein the RRC message further comprises an indication that the reason for the contention-based random access procedure is beam failure recovery.

17. The method of claim 15 wherein the identity of the wireless device is a Cell Radio Network Temporary Identifier, C-RNTI, of the wireless device, and the message comprises the RRC message and a C-RNTI MAC CE that comprises the C-RNTI of the wireless device.

18. The method of claim 15 wherein the RRC message further comprises information that indicates an old serving beam of the wireless device.

19. The method of claim 15 wherein the RRC message further comprises radio quality measurement results for one or more other beams, beam sets, Synchronization Signal Blocks, SSBs, and/or SSB groups.

20. A wireless device for beam failure recovery in a wireless communication system, the wireless device adapted to:
detect a beam failure; and
perform a contention-based random access procedure upon detecting the beam failure, wherein the wireless device is adapted to perform the contention-based random access procedure by being adapted to:
transmit, to a network node, a random access preamble;
receive, from the network node, a random access response; and
transmit, to the network node, a message comprising an identity of the wireless device and information that indicates a new serving beam for the wireless device, wherein:
the message provides an implicit indication that a reason for the contention-based random access procedure is beam failure recovery; and
the message comprises an existing Medium Access Control, MAC, Control Element, CE, where one or more unused bits in the existing MAC CE are used to convey the information that indicates the new serving beam for the wireless device.

21. (canceled)

22. A wireless device for beam failure recovery in a wireless communication system, the wireless device comprising:
one or more transmitters and one or more receivers; and
processing circuitry associated with the one or more transmitters and the one or more receivers, the processing circuitry configured to cause the wireless device to:
detect a beam failure; and
perform a contention-based random access procedure upon detecting the beam failure, wherein the processing circuitry is configured to cause the wireless device to perform the contention-based random access procedure by being configured to cause the wireless device to:
transmit, to a network node, a random access preamble;
receive, from the network node, a random access response; and
transmit, to the network node, a message comprising an identity of the wireless device and information that indicates a new serving beam for the wireless device, wherein:
the message provides an implicit indication that a reason for the contention-based random access procedure is beam failure recovery; and
the message comprises an existing Medium Access Control, MAC, Control Element, CE, where one or more unused bits in the existing MAC CE are used to convey the information that indicates the new serving beam for the wireless device.

23. (canceled)

24. A method performed by a base station for beam failure recovery in a wireless communication system, comprising:
performing, together with a wireless device, a contention-based random access procedure wherein:
performing the contention-based random access procedure comprises:
receiving, from the wireless device, a random access preamble;
transmitting, to the wireless device, a random access response; and
receiving, from the wireless device, a message comprising an identity of the wireless device and information that indicates a new serving beam for the wireless device, wherein:
the message provides an implicit indication that a reason for the contention-based random access procedure is beam failure recovery; and
the message comprises an existing Medium Access Control, MAC, Control Element, CE, wherein one or more unused bits in the existing MAC CE are used to convey the information that indicates the new serving beam for the wireless device.

25. (canceled)

26. The method of claim 24 wherein the information that indicates the new serving beam for the wireless device comprises:
an index that indicates the new serving beam;
a Synchronization Signal Block, SSB, or SSB group index associated with the new serving beam;
a Channel State Information Reference Symbol, CSI-RS, set index associated with the new serving beam; and/or
a Transmission Configuration Indicator, TCI, state index associated with the new serving beam.

27. (canceled)

28. (canceled)

29. The method of claim 24 wherein the identity of the wireless device is a Cell Radio Network Temporary Identifier, C-RNTI, of the wireless device, and the message comprises a C-RNTI MAC CE that comprises the C-RNTI of the wireless device.

30. The method of claim 24 wherein the identity of the wireless device is a Cell Radio Network Temporary Identifier, C-RNTI, of the wireless device, and the message comprises an extended C-RNTI MAC CE that comprises the C-RNTI of the wireless device and the information that indicates the new serving beam for the wireless device.

31. The method of claim 24 wherein the message further comprises information that indicates that the reason for the contention-based random access procedure is beam failure recovery.

32. The method of claim 24 wherein the message further comprises information that indicates an old serving beam of the wireless device.

33. The method of claim 24 wherein the message further comprises radio quality measurement results for:
one or more other beams;
one or more other beam sets;
one or more other SSBs; and/or
one or more other SSB groups.

34. The method of claim 24 wherein the identity of the wireless device is a Cell Radio Network Temporary Identifier, C-RNTI, of the wireless device, and the message comprises a C-RNTI MAC CE that comprises the C-RNTI of the wireless device.

35. The method of claim 34 wherein the implicit indication that the reason for the contention-based random access procedure is beam failure recovery comprises a logical channel identifier, ID, that is different from a logical channel ID comprised in a C-RNTI MAC CE for Radio Resource Control, RRC, connection re-establishment.

36. The method of claim 24 wherein receiving, from the wireless device, the random access preamble comprises receiving, from the wireless device, a random access preamble selected from a reserved preamble group for beam failure recovery, wherein the random access preamble indicates the new serving beam and that the reason for the contention-based random access procedure is beam failure recovery.

37. The method of claim 24 wherein receiving, from the wireless device, the random access preamble comprises receiving, from the wireless device, a random access preamble on a random access channel resource selected from a reserved resource group for beam failure recovery, wherein the random access channel resource indicates the new serving beam and that the reason for the contention-based random access procedure is beam failure recovery.

38. The method of claim 24 wherein the message comprises a Radio Resource Control, RRC, message that comprises the information that indicates the new serving beam for the wireless device.

39. The method of claim 38 wherein the RRC message further comprises an indication that the reason for the contention-based random access procedure is beam failure recovery.

40. The method of claim 38 wherein the identity of the wireless device is a Cell Radio Network Temporary Identifier, C-RNTI, of the wireless device, and the message comprises the RRC message and a C-RNTI MAC CE that comprises the C-RNTI of the wireless device.

41. The method of claim 38 wherein the RRC message further comprises information that indicates an old serving beam of the wireless device.

42. The method of claim 38 wherein the RRC message further comprises radio quality measurement results for one or more other beams, beam sets, Synchronization Signal Blocks, SSBs, and/or SSB groups.

43. The method of claim 24 further comprising:
determining, based on the implicit indication, that the contention-based random access procedure is being performed for beam failure recovery; and
refraining from initiating a RRC connection re-establishment procedure upon determining that the contention-based random access procedure is being performed for beam failure recovery.

44. A base station for beam failure recovery in a wireless communication system, the base station adapted to:
perform, together with a wireless device, a contention-based random access procedure wherein:
the base station is adapted to perform the contention-based random access procedure by being adapted to:
receive, from the wireless device, a random access preamble;
transmit, to the wireless device, a random access response; and
receive, from the wireless device, a message comprising an identity of the wireless device and information that indicates a new serving beam for the wireless device, wherein:
the message provides an implicit indication that a reason for the contention-based random access procedure is beam failure recovery; and
the message comprises an existing Medium Access Control, MAC, Control Element, CE, wherein one or more unused bits in the existing MAC CE are used to convey the information that indicates the new serving beam for the wireless device (212).

45. (canceled)

46. A base station for beam failure recovery in a wireless communication system, the base station comprising:
processing circuitry configured to cause the base station to perform, together with a wireless device, a contention-based random access procedure wherein:
the processing circuitry is configured to cause the base station to perform the contention-based random access procedure by being configured to cause the base station to:
receive, from the wireless device, a random access preamble;
transmit, to the wireless device, a random access response; and
receive, from the wireless device, a message comprising an identity of the wireless device and information that indicates a new serving beam for the wireless device, wherein:
the message provides an implicit indication that a reason for the contention-based random access procedure is beam failure recovery; and
the message comprises an existing Medium Access Control, MAC, Control Element, CE, wherein one or more unused bits in the existing MAC CE are used to convey the information that indicates the new serving beam for the wireless device.

47. (canceled)
